(19) United States
(12) Patent Application Publication
(10) Pub. No.: US 2025/0071652 A1
(43) Pub. Date: Feb. 27, 2025

(54) UE-BASED HANDLING OF QOE SESSION STATUS INDICATIONS DURING CONDITIONAL HANDOVER

(71) Applicant: Telefonaktiebolaget LM Ericsson (publ), Stockholm (SE)

(72) Inventors: Johan RUNE, Lidingö (SE); Luca LUNARDI, Genova (IT); Cecilia EKLÖF, Täby (SE); Ali PARICHEHREHTEROUJENI, Linköping (SE)

(21) Appl. No.: 18/726,734

(22) PCT Filed: Dec. 21, 2022
(86) PCT No.: PCT/IB2022/062640

§ 371 Date: Jul. 3, 2024

Related U.S. Application Data
(60) Provisional application No. 63/298,172, filed on Jan. 10, 2022.

(51) Int. Cl. H04W 36/36; H04W 36/00; H04W 36/30

(52) U.S. Cl. CPC H04W 36/362; H04W 36/0033; H04W 36/304

(57) ABSTRACT

A method performed by a UE in a wireless communication network includes receiving a configuration for a conditional handover (CHO) from a source node to a candidate target node, executing the CHO to the candidate target node, and in connection with executing the CHO, and providing to the candidate target node a session status indication for an application session of the UE. A method performed by a target node in a wireless communication network includes receiving a CHO of a UE from a source node to the target node. In connection with the CHO, the target node receives a session status indication indicating a status for an application session of the UE, and handles the application session in accordance with the session status indication.

### BACKGROUND

The present disclosure relates to wireless communication systems. In particular, the present disclosure relates to conditional handover in a wireless communication system.

Quality of Experience (QoE) measurements, also referred to as “application layer measurements,” have been specified for the Long Term Evolution (LTE) and Universal Mobile Telecommunication System (UMTS) standards and are being specified for the New Radio (NR) standard in 3GPP Release 17. The purpose of the application layer measurements is to measure the end user experience when using certain applications. Currently QoE measurements are supported for streaming services and for Mobility Telephony Service for IP Multimedia Subsystem (IMS) services. For NR, it is likely that at least virtual reality (VR) is added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (commonly referred to as QoE reports) to the network by means of radio resource control (RRC) signalling. An application layer measurement configuration (also called QoE measurement configuration or QoE configuration) that the radio access network (RAN) receives from the operation and maintenance (OAM) system or the core network (CN) is encapsulated in a transparent container, which is forwarded to a user equipment (UE) in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP Release 17, a new study item for “Study on NR QoE management and optimizations for diverse services” for NR has been approved and concluded. The specification work for 3GPP Release 17 is still ongoing. The purpose of the study item is to study solutions for QoE measurements in NR. QoE management in NR will not just collect the quality of experience parameters of streaming services, but also consider the typical performance requirements of diverse services such as AR/VR and Ultra-Reliable Low-Latency Communication (URLLC). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) should be sent to. Such an entity may be referred to as a Measurement Collection Entity (MCE), but may also be referred to as a Trace Collection Entity (TCE). The currently specified service types are Multimedia Telephony Service for IMS (MTSI) and Dynamic Adaptive Streaming over HTTP (DASH). In 3GPP Release 17, the service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two varieties: management-based QoE configuration and signaling-based QoE configuration. In both cases, the QoE configuration originates in the OAM system or some other administrational entity dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, for example, because the user of the UE has filed a complaint. The OAM system sends the s-based QoE configuration to the Home Subscriber Server (HSS) (in LTE) or UDM (in NR), which forwards the QoE configuration to the UE's current core network node, e.g. a Mobility Management Entity (MME) in LTE or an Access and Mobility Function (AMF) in NR. The CN then forwards the s-based QoE configuration to the RAN node that serves the concerned UE and the RAN forwards it to the UE.

The service type indication and the container with the measurement instructions are forwarded to the UE. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR, and possibly in LTE, a globally unique QoE reference will be associated with each QoE configuration. The QoE reference is included in the container with measurement instructions and also sent to the RAN (i.e. the gNodeB or gNB in NR). For the communication between the gNB and the UE, the QoE reference is replaced by a shorter identifier denoted as measConfigAppLayerId, which is locally unique within a UE (i.e. there is a one-to-one mapping between a measConfigAppLayerId and a QoE reference for each QoE configuration provided to a UE). The measConfigAppLayerId is stored in the UE Access Stratum and also forwarded together with the service type indication and the container with the measurement instructions.

Reports with collected QoE measurement results (QoE reports) are sent from the UE application layer to the UE Access Stratum, which forwards them to the RAN, which forwards them to the MCE. QoE reporting can be configured to be periodic or only sent at the end of an application session. Furthermore, the RAN can instruct the UE to pause QoE reporting, for example, in case the cell/gNB is in a state of overload.

The RAN is not aware of when an application session with an associated QoE measurement session is ongoing, and the UE Access Stratum is also not automatically aware of this. To alleviate this, session start/stop indications can be introduced, which will be sent from the application layer in the UE to the UE AS and from the UE AS to the RAN. A session stop indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the entire session, even during a handover situation. It is also discussed to let the UE continue with the QoE measurements on an ongoing application session until the application session ends, even if the UE in the meantime moves out of the configured area scope.

### RAN Visible QoE (RVQoE)

An extension of the QoE framework, which has been studied for 3GPP Release 17 and which is currently being specified in 3GPP is the concept of RAN visible QoE (RVQoE). The regular QoE reports are intended for the MCE, which is an entity outside the RAN, e.g. a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as changing various parameters related to the scheduling of the UE and the data flows related to the application session.

QoE measurement in Universal Terrestrial Radio Access Network (UTRAN)—Application Layer Measurement Capabilities

The RAN can request the UE (using a UE Capability Enquiry RRC message) to report its capability, as shown in FIG. 1.

In response, the UE can provide information about its capability using the UE Capability Information RRC message as shown in FIG. 2.

The UE can indicate support for QoE measurement and reporting in the UE Capability Information message. The relevant indications are included in the “Measurement capability” information element (IE), which in turn is included in the “UE radio access capability” IE, which is included in the UE Capability Information message.

### UTRAN-QoE Measurement Configuration—RRC Signaling

To configure QoE measurement in the UE, the UTRAN can send a Measurement Control RRC message containing the “Application layer measurement configuration” IE as shown in FIG. 3.

### UTRAN—QoE Measurement Reporting—RRC Signaling

The UE can send QoE measurement results via UTRAN to the Collecting Entity using the “Measurement Report” RRC message including the “Application layer measurement reporting” IE as shown in FIG. 4.

The UE may also perform Cell Update to indicate that an application layer measurement report is available in the UE.

### E-UTRAN-Application Layer Measurement Capabilities

For enhanced UTRAN (E-UTRAN), the UE capability transfer is used to transfer UE radio access capability information from the UE to E-UTRAN as shown in FIG. 5.

The UE-EUTRA-Capability IE is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the “UE-EUTRA-Capability-v1530-IEs” IE which can be used by the UE to indicate whether the UE supports QoE Measurement Collection for streaming services and/or MTSI services.

### E-UTRAN-QoE Measurement Configuration Setup and Release—RRC Signaling

The RRCConnectionReconfiguration message is used to reconfigure the UE to setup or release the UE for Application Layer measurements. This is signaled in the measConfigAppLayer-r15 IE within the OtherConfig IE.

The setup includes the transparent container measConfigAppLayerContainer IE which specifies the QoE measurement configuration for the application of interest and the serviceType IE which indicates the Application (or service) for which the QoE measurements are being configured. Supported services are streaming and MTSI.

### E-UTRAN-Application Layer Measurement Reporting

FIG. 6 illustrates the application layer measurement reporting procedure. The purpose of this procedure is to transfer the application layer measurement report to E-UTRAN, so that the E-UTRAN can forward the report to the O&M system, e.g. to a MCE or a TCE.

A UE capable of application layer measurement reporting in RRC_CONNECTED state may initiate the procedure when configured with application layer measurement, i.e. when the measConfigAppLayer IE has been configured by E-UTRAN. For this purpose, the UE uses the MeasReportAppLayer RRC message, which contains the measReportAppLayerContainer IE and the serviceType IE.

### UE Application Layer Measurement Configuration

For signaling based QoE configuration, the configuration is signaled to the RAN (eNB) from the MME using the control plane protocol for the S1 interface, i.e. S1AP.

The “UE Application layer measurement configuration” IE defines configuration information for the QoE Measurement Collection (QMC) function

### Area Scope for QoE Measurements

The area scope parameter defines the area in terms of cells or Tracking Area/Routing Area/Location Area where the QMC shall take place. If the parameter is not present, the QMC shall be done throughout the PLMN specified in PLMN target.

The area scope parameter in UMTS is either a list of cells, identified by CGI, a list of Routing Area, identified by RAI or a list of Location Area, identified by LAI. The area scope parameter in LTE is either a list of cells, identified by E-UTRAN-CGI, or a list of Tracking Area, identified by Tracking Area Code (TAC). For NR, the area scope parameter will be either a list of cells, or a list of tracking areas. The parameter is mandatory if area based QMC is requested.

### Connected State Mobility

In connected state, in the 3GPP specifications known as the RRC_CONNECTED state, the UE has an active connection to the network for sending and receiving of data and signaling. In connected state, mobility is controlled by the network to ensure connectivity is retained to the UE with no interruption or noticeable degradation of the provided service as the UE moves between the cells within the network. To support network-controlled connected state mobility, as requested/configured by the network, the UE is required to search and perform measurements on neighbor cells both on the current carrier frequency (intra-frequency) and on other carrier frequencies (inter-frequency). The connected state mobility is network-controlled, and the UE does not take any autonomous decisions for when to trigger a handover to a neighbor cell (except to some extent when the UE is configured for Conditional Handover, which is described below). Instead, the UE sends the measurement results obtained for the serving and neighboring cells to the network where a decision is taken whether or not to perform a handover to one of the neighbor cells. Two flavors of connected state mobility are described in this section: regular handover and conditional handover.

### Regular Handover

During regular handover (also referred to as just “handover”) the UE is moved from a source node using a source cell connection, to a target node using a target cell connection where the target cell connection is associated with a target cell controlled by the target node. In other words, during a handover, the UE moves from the source cell to a target cell.

The source node and the target node may also be referred to as the source access node and the target access node or the source radio network node (i.e. the source RAN node) and the target radio network node (i.e. the target RAN node). In the 5G system the source node and the target node are referred to as the source gNB and the target gNB.

In some cases, the source node and the target node are different nodes, such as different gNBs. These cases are also referred to as inter-node or inter-gNB handover. In other cases, the source node and the target node are one and the same node, such as the same gNB. These cases are also referred to as intra-node or intra-gNB handover and covers the case when the source and target cells are controlled by the same node.

In yet another case, handover is performed within the same cell and thus also within the same node controlling that cell. These cases are referred to as intra-cell handover.

It should also be understood that the source node (or source access node) and the target node (target access node) refer to a role served by a given access node during a handover of a specific UE. For example, a given access node may serve as source access node during handover of one UE, while it also serves as the target access node during handover of a different UE. In case of an intra-node or intra-cell handover of a given UE, the same access node serves both as the source access node and target access node for that UE.

An inter-node handover can further be classified as an Xn-based or NG-based handover depending on whether the source and target node communicate directly using the Xn interface or indirectly via the Core Network using the NG interface.

FIG. 7 shows a simplified signaling flow between the UE, the source gNB and the target gNB during an Xn-based inter-node handover in NR.

Note that control plane data (i.e. RRC messages such as the measurement report (MeasurementReport), Handover Command and Handover Complete messages) are transmitted on Signaling Radio Bearers (SRBs) while the user plane data is transmitted on Data Radio Bearers (DRBs).

The operations of FIG. 7 are described as follows.

Steps 301-302. The UE has an active connection to the source gNB where user data is sent and received to/from the network. Due to some trigger in the source gNB, e.g. a measurement report received from the UE, the source gNB decides to handover the UE to a target (neighbor) cell controlled by the target gNB.

Step 303. The source gNB sends the XnAP HANDOVER REQUEST message to the target gNB passing a transparent RRC container with necessary information to prepare the handover at the target side. The information includes for example the target cell id, the target security key, the current source configuration and UE capabilities.

Step 304. The target gNB prepares the handover and responds with the XnAP HANDOVER REQUEST ACKNOWLEDGE message to the source gNB, which includes the Handover Command (a RRCReconfiguration message containing the reconfiguration WithSync field, often written as “HandoverCommand”) to be sent to the UE. The Handover Command includes configuration information that the UE should apply once it connects to the target cell, e.g., random access configuration, a new C-RNTI assigned by the target node, security parameters, etc.

Step 305. The source gNB triggers the handover by sending the Handover Command (received from the target gNB in the previous step) to the UE.

Step 306. Upon reception of the Handover Command the UE releases the connection to the old (source) cell, starts the handover supervision timer T304, and starts to synchronize to the new (target) cell.

Steps 307-309. The source gNB stops scheduling any further downlink (DL) user data to the UE and sends the XnAP SN STATUS TRANSFER message to the target gNB indicating the latest PDCP SN transmitter and receiver status. The source gNB now also starts to forward DL user data received from the Core Network to the target gNB, which buffers this data for now.

Step 310. Once the UE the has completed the random access procedure in the target cell, the UE stops the T304 timer and sends the Handover Complete message to the target gNB.

Step 311. Upon receiving the Handover Complete message, the target gNB starts sending (and receiving) user data to/from the UE. The target gNB requests the CN to switch the DL user data path between the User Plane Function (UPF) and the source node to the target node (communication to the CN is not shown in FIG. 7). Once the path switch is completed, the target gNB sends the XnAP UE CONTEXT RELEASE message to the source gNB to release all resources associated to the UE.

### SUMMARY

A method performed by a UE in a wireless communication network according to some embodiments includes receiving a configuration for a CHO from a source node to a candidate target node, executing the CHO to the candidate target node, and in connection with executing the CHO, and providing to the candidate target node a session status indication for an application session of the UE.

The session status indication may include an indication of an ongoing/not ongoing status of the application session.

The session status indication may include one or more session start/stop/end indications for the application session that were generated while the UE was configured for the CHO to the candidate target node.

In some embodiments, the session status indication is associated with a QoE configuration in the UE.

The application session may include a QoE measurement session or an application session for which QoE measurement is applied.

In some embodiments, the session status indication is provided to the candidate target node in a RRC message.

The RRC message may include a RRCReconfigurationComplete message, a Handover Complete message, a MeasurementReportAppLayer message, a SRB4 message, or a UEAssistanceInformation message.

The method may further include storing one more session start/stop/end indications that were generated while the UE was configured for CHO to the source node.

In some embodiments, the UE stores only a latest session start/stop/end indication that was generated while the UE was configured for CHO to the source node.

The method may further include discarding stored session start/stop/end indications as new session start/stop/end indications are generated.

The method may further include receiving a configuration for handling session status indications as part of a CHO, and implementing the configuration for handling session status indications.

The configuration for handling session status indications may be indicated in broadcast system information of a target cell, indicated in dedicated signaling to the UE, indicated together with an associated QoE configuration, indicated in an update of a QoE configuration provided by the source node or the candidate target node, indicated by the source node in an RRCReconfiguration message configuring the UE for CHO, indicated by the candidate target node in a CHO command, indicated in an acknowledgement of a session start indication received while the UE was configured for CHO, indicated in an acknowledgement of a session stop indication or session end indication received while the UE was configured for CHO, indicated in a standard specification, and/or configured in a Universal Subscriber Identity Module of the UE at time of subscription.

The method may further include receiving a second configuration for CHO while configured for CHO, and sending an updated version of session status indication for each of a plurality of QoE configurations in the UE to the source node.

The method may further include, upon successfully executing the second configuration for CHO, indicating to the candidate target node a difference between a session status at the time of execution of the second configuration for CHO and at the time of receiving the second configuration for CHO.

A UE according to some embodiments includes a processor, and a memory coupled to the processor. The memory includes computer program instructions that, when executed by the processor, cause the processor to perform operations of receiving a configuration for a CHO from a source node to a candidate target node, executing the CHO to the candidate target node, and in connection with executing the CHO, providing to the candidate target node a session status indication for an application session of the UE.

A computer program according to some embodiments includes computer readable program code that, when executed by a processor, cause the processor to perform operations of receiving a configuration for a CHO from a source node to a candidate target node, executing the CHO to the candidate target node, and in connection with executing the CHO, providing to the candidate target node a session status indication for an application session of the UE.

A computer program product according to some embodiments includes a non-transitory computer readable storage medium including the computer readable program code.

A method performed by a target node in a wireless communication network according to some embodiments includes receiving a CHO of a UE from a source node to the target node, in connection with the CHO, receiving a session status indication indicating a status for an application session of the UE, and handling the application session in accordance with the session status indication.

The method may further include receiving a handover request indicating that it is a candidate node of a CHO procedure involving the UE, wherein the handover request includes the session status indication.

In some embodiments, the session status indication is indicated per QoE configuration in the UE. In some embodiments, the session status indication is received in a RRC message.

In some embodiments, the RRC message includes a RRCReconfigurationComplete message, a Handover Complete message, a MeasurementReportAppLayer message, a SRB4 message, or a UEAssistanceInformation message.

In some embodiments, the session status indication includes a difference between a session status at the time of execution of the second configuration for CHO and at the time of receiving the second configuration for CHO.

The method session status indication may include an indication of an ongoing/not ongoing status of the application session.

The session status indication may include one or more session start/stop/end indications for the application session that were generated while the UE was configured for the CHO to the candidate target node.

The session status indication may be associated with a QoE configuration in the UE.

The application session may include a QoE measurement session or an application session for which QoE measurement is applied.

A network node according to some embodiments includes a processor, and a memory coupled to the processor. The memory includes computer program instructions that, when executed by the processor, cause the processor to perform operations of receiving a CHO of a UE from a source node to the target node, in connection with the CHO, receiving a session status indication indicating a status for an application session of the UE, and handling the application session in accordance with the session status indication.

A computer program according to some embodiments includes computer readable program code that, when executed by a processor, cause the processor to perform operations of receiving a CHO of a UE from a source node to the target node, in connection with the CHO, receiving a session status indication indicating a status for an application session of the UE, and handling the application session in accordance with the session status indication.

A computer program product according to some embodiments includes a non-transitory computer readable storage medium including the computer readable program code.

A method performed by a source node in a wireless communication network according to some embodiments includes configuring a UE with a configuration for CHO to a candidate target node, configuring the UE with a configuration for providing to the candidate target node a session status indication for an application session of the UE, and executing a handover of the UE from the source node to the candidate target node.

The configuration for providing the session status indication for the application session may be provided per QoE configuration in the UE.

The source node may provide the configuration for providing the session status indication in broadcast system information of a target cell, in dedicated signaling to the UE, together with an associated QoE configuration, in an update of a QoE configuration provided by the source node or the candidate target node, in an RRCReconfiguration message configuring the UE for CHO, in an acknowledgement of a session start indication received while the UE was configured for CHO, in an acknowledgement of a session stop indication or session end indication received while the UE was configured for CHO, and/or in a standard specification.

The method may further include receiving one or more session start/stop/end indications that were generated while the UE was configured for CHO, and transmitting the one or more session start/stop/end indications to the candidate target node in connection with the handover.

The session status indication may include an indication of an ongoing/not ongoing status of the application session.

The method session status indication may include one or more session start/stop/end indications for the application session that were generated while the UE was configured for the CHO to the candidate target node.

The session status indication may be associated with a QoE configuration in the UE.

The application session includes a QoE measurement session or an application session for which QoE measurement is applied.

A network node according to some embodiments includes a processor, and a memory coupled to the processor. The memory includes computer program instructions that, when executed by the processor, cause the processor to perform operations of configuring a UE with a configuration for CHO to a candidate target node, configuring the UE with a configuration for providing to the candidate target node a session status indication for an application session of the UE, and executing a handover of the UE from the source node to the candidate target node.

A computer program according to some embodiments includes computer readable program code that, when executed by a processor, cause the processor to perform operations of configuring a UE with a configuration for CHO to a candidate target node, configuring the UE with a configuration for providing to the candidate target node a session status indication for an application session of the UE, and executing a handover of the UE from the source node to the candidate target node.

A computer program product according to some embodiments includes a non-transitory computer readable storage medium including the computer readable program code.

### BRIEF DESCRIPTION OF THE DRAWINGS

FIG. 1 illustrates a UE Capability Enquiry RRC message.

FIG. 2 illustrates a UE Capability Information RRC message.

FIG. 3 illustrates a Measurement Control RRC message.

FIG. 4 illustrates a Measurement Report RRC message including an application layer measurement reporting information element.

FIG. 5 illustrates a UE capability transfer that is used to transfer UE radio access capability information from the UE to E-UTRAN.

FIG. 6 illustrates the application layer measurement reporting procedure.

FIG. 7 shows a simplified signaling flow between the UE, the source gNB and the target gNB during an Xn-based inter-node handover in NR.

FIGS. 8A and 8B illustrate the principle of conditional handover (CHO).

FIG. 9 illustrates operations of a UE according to some embodiments.

FIG. 10 illustrates operations of a candidate target node according to some embodiments.

FIG. 11 illustrates operations of a source node according to some embodiments.

FIG. 12 illustrates an example of a communication system in accordance with some embodiments.

FIG. 13 illustrates a UE in accordance with some embodiments.

FIG. 14 illustrates a network node in accordance with some embodiments.

FIG. 15 is a block diagram of a host.

FIG. 16 is a block diagram illustrating a virtualization environment in which functions implemented by some embodiments may be virtualized.

FIG. 17 shows a communication diagram of a host communicating via a network node with a UE over a partially wireless connection in accordance with some embodiments.

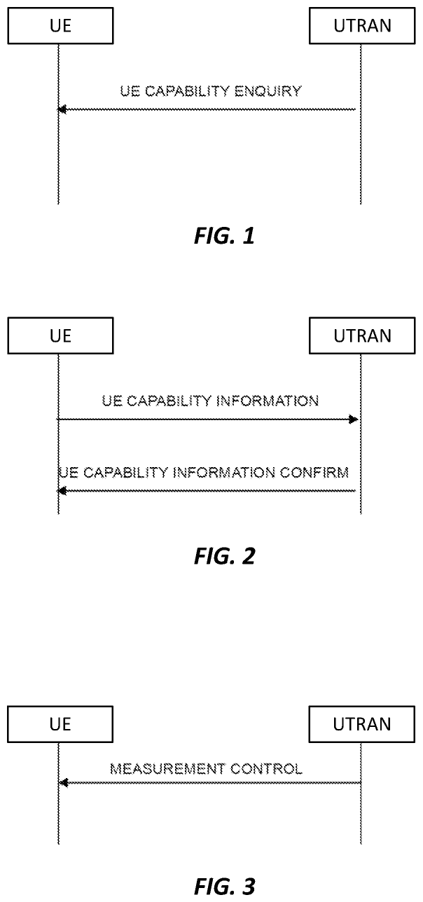

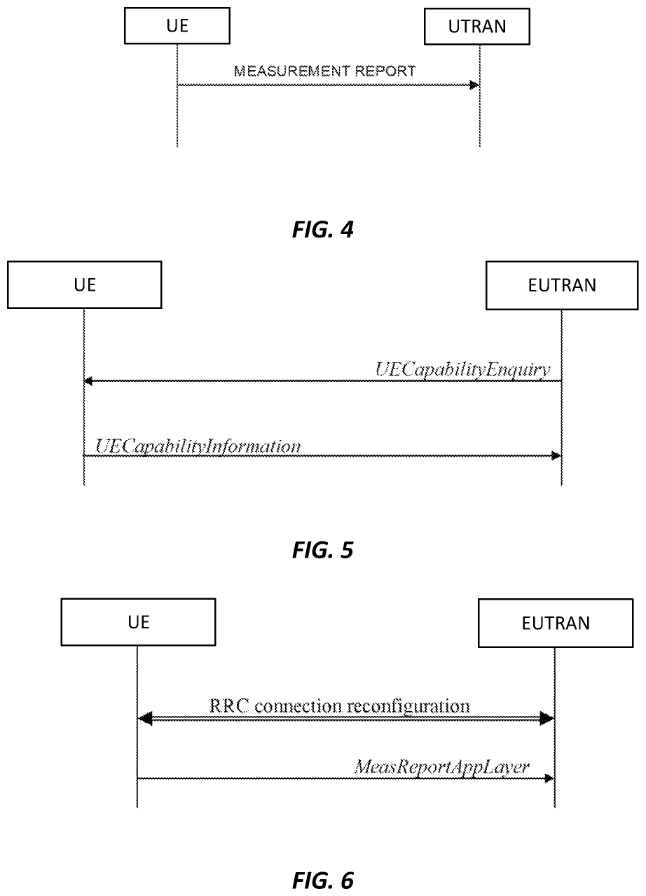

### DETAILED DESCRIPTION

In 3GPP Release 16, a new handover concept called Conditional Handover (CHO) was introduced in purpose to improve mobility robustness. CHO addresses reliability issues in the handover procedure if, for example, the measurement report sent from the UE, or the Handover Command sent from the network to the UE, is lost due to quality issues with the radio link between the UE and the source node. This may occur when the handover is performed close to the cell edge.

To deal with this issue, CHO enables the network to transmit a handover command to the UE when the quality of the radio link is still good, i.e., before the UE gets close to the cell edge. The network configures the UE with one or more candidate target cells and with a CHO specific execution condition for each target cell. The CHO execution conditions are evaluated by the UE. When the CHO execution conditions are fulfilled for one of the candidate target cells, the UE triggers a handover to that target cell.

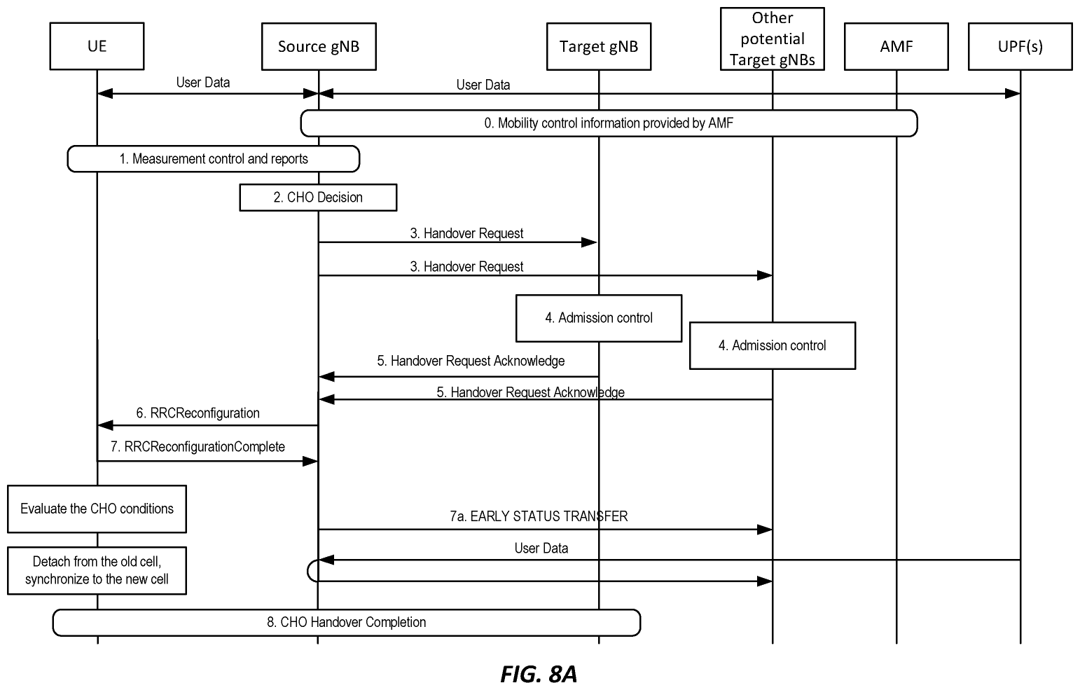

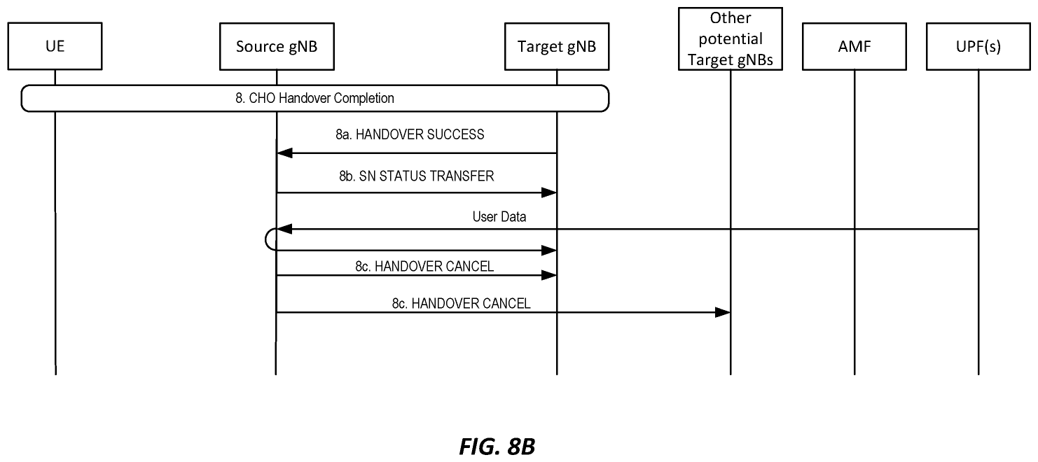

The principle for CHO is illustrated in FIGS. 8A and 8B. Based on e.g. a Measurement Report received from the UE in step 1, the source node decides to configure the UE for CHO (step 2 in FIG. 8A).

The source node prepares one or more candidate target nodes by including a CHO indicator and the current UE configuration in the HANDOVER REQUEST message sent over Xn (step 3). Unlike a regular (non-CHO) handover, CHO enables the network to prepare the UE with more than one candidate target cell. Each candidate target cell has its own target cell configuration and its own CHO execution condition. The target cell configuration is generated by the candidate target node, while the CHO execution condition is configured by the source node. For CHO in 3GPP Release 16, the CHO execution condition may consist of one or two trigger conditions, namely, the A3 and A5 signal strength/quality based events.

As in a regular (non-CHO) handover, the Handover Command sent to the UE in the RRCReconfiguration message in step 6 is generated by the candidate target node but transmitted to the UE in the source cell by the source node. In case of an inter-node handover (as in FIG. 8A), the Handover Command is sent from the candidate target node to the source node within the Xn HANDOVER REQUEST ACKNOWLEDGE message (step 5) as a transparent container, meaning that the source node does not change the content of the Handover Command.

The target cell configuration and the CHO execution condition for each candidate target cell provided by the network to the UE are collectively known as the CHO configuration. When received by the UE in the Handover Command in the RRCReconfiguration message in step 6, the target cell configuration is not applied immediately as in a regular (non-CHO) handover. Instead, the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled in order to trigger the CHO to the candidate target cell.

When the CHO execution condition is fulfilled for one of the candidate target cells, the UE detaches from the source cell, applies the associated target cell configuration, and starts the handover supervision timer T304. The UE then connects to the target node as in a regular handover (step 8). Any CHO configuration stored in the UE after completion of the RRC handover procedure is released.

The target node sends the HANDOVER SUCCESS message over Xn to the source node to inform that the UE has successfully accessed the target cell (step 8a of FIG. 8B). Triggering of data forwarding to the target node is typically done after receiving the HANDOVER SUCCESS message in the source node—this is also known as “late data forwarding”. As an alternative, data forwarding may be triggered at an earlier stage in the handover procedure, after receiving the RRCReconfigurationComplete message from the UE (step 7). This mechanism is also known as “early data forwarding”.

If more than one candidate target cell was configured to the UE during the Handover Preparation phase, then the source node needs to cancel the CHO for the candidate target cells not selected by the UE. The source node sends the HANDOVER CANCEL message over Xn towards the other signalling connection(s) or other candidate target node(s) to cancel the CHO and thus to initiate a release of the reserved resources in the target node(s) (step 8c). During a regular (non-CHO) handover, if the handover attempt fails due to e.g. a radio link failure or expiry of timer T304, the UE will typically perform a cell selection and continue with a re-establishment procedure. But when a CHO execution attempt fails and the selected cell is associated to a candidate target cell included in the CHO configuration, the UE will instead attempt a CHO execution to the selected target cell.

There currently exist certain challenges. When CHO configuration is prepared for a UE, the candidate target nodes (e.g. candidate target gNBs) are prepared with the configuration the UE has in the source node and the UE is prepared through an RRCReconfiguration message (in NR) containing the configuration to apply when/if the UE eventually connects to the candidate target node, or one of the candidate target nodes. The time between this preparation and the possible execution of the CHO is essentially unpredictable.

Furthermore, the UE configuration information sent from the source node to the candidate target nodes may include information (per QoE configuration) of whether a session (i.e., an application session with an associated QoE measurement session) is ongoing in the UE. This is rational during regular handover, because the target node may use this information as input to a possible decision to release the QoE configuration in the UE (e.g. if the UE has exited the area scope associated with the QoE configuration) or for decisions and actions related to alignment of MDT measurements and QoE measurements.

However, in combination with CHO, this poses a problem, since the session status may change—even multiple times—while the UE is configured with CHO, i.e., between the time of preparing the CHO configuration and the time of execution of the CHO. Every time such a change occurs, and the UE accordingly signals a session start or session stop/end indication to the source node, the source node has to update the candidate target nodes so that they have an up-to-date UE configuration for the UE for which CHO has been configured. In the worst case, each such update also results in a need to change the configuration (for each candidate target cell controlled by the candidate target node) that the candidate target node has prepared for the UE (and which has been transferred to the UE via the source node) to be applied if the UE eventually connects to the candidate target node.

Certain aspects of the disclosure and their embodiments may provide solutions to these or other challenges. In brief, some embodiments described herein provide means by which the source node (in a CHO configuration) can avoid having to update the candidate target node or nodes when the UE's session status changes while configured with CHO. This may be achieved without compromising the benefits the target node can achieve by knowing the session status of a UE that connects to the target node as a result of a CHO execution.

To this end, in some embodiments, a UE is configured to indicate its session status (per QoE configuration in the UE) to the target node when it connects to a target node during a CHO execution. This indication may be sent to the target node in the RRCReconfigurationComplete message constituting the Handover Complete message, or a MeasurementReportAppLayer message (or some other message on SRB4), or a UEAssistanceInformation message. The indication itself may come in different variants, including parameters of ASN.1 type ENUMERATED or BOOLEAN, or the UE may retroactively send any session start/stop/end indications that were generated while the UE was configured for the CHO (i.e., between the time of receiving the CHO configuration for the concerned target cell and the time of connecting to the target node in the target cell).

While configured for CHO, the UE may or may not send session start/stop/end indications to the source node, depending on the embodiment.

The UE's behavior and the various features, options and parameter values involved in the solution may be configurable (or specified in standard specification(s)) in various alternative ways.

Accordingly, some embodiments provide means to avoid having to update the candidate target nodes when the UE's session status changes while configured with CHO. To compensate for the lack of such updates (which potentially results in the target having partly outdated information about the UE's configuration in the source cell), the UE sends an indication of its session status (per QoE configuration in the UE) as soon as it executes a CHO and successfully connects to a candidate target node.

Certain embodiments may provide one or more of the following technical advantages. For example, one advantage of the embodiments described herein is that potentially extensive and unnecessary (in case of multiple QoE measurement status changes during CHO execution) inter-gNB and gNB-UE signaling of configuration updates may be avoided.

Some of the embodiments contemplated herein will now be described more fully with reference to the accompanying drawings. Embodiments are provided by way of example to convey the scope of the subject matter to those skilled in the art.

In the present description, the terms “UE”, “terminal equipment” and “wireless terminal” are used interchangeably. The terms MCE and TCE are used interchangeably. The terms “source node”, “target node” and “candidate target node” are often used in the solution description. The “node” in these terms should be understood as typically being a RAN node in NR, LTE or UMTS, e.g. an RNC or a Node B in UMTS, an eNB (or an ng-eNB or a part of an eNB in case the eNB is split into multiple entities/nodes in a split eNB architecture) in LTE or a gNB in NR, or an en-gNB or a part of a gNB in NR (when the split gNB architecture is applied, dividing the gNB into multiple separate entities or nodes). The different entities/nodes belonging to a gNB in a split gNB architecture constitute a range of different nodes/entities, e.g.: gNB-CU (often referred to as just CU), gNB-DU (often referred to as just DU), gNB-CU-CP and gNB-CU-UP. As mentioned above, the eNB may also be subject to a split architecture, in which case it may be split into an eNB-CU and one or more eNB-DUs, and wherein the eNB-CU may be further divided into an eNB-CU-CP and an eNB-CU-UP. Furthermore, the “node” in the terms may also refer to an IAB-donor, IAB-donor-CU, IAB-donor-DU, IAB-donor-CU-CP, or an IAB-donor-CU-UP.

The terms “application layer measurement configuration”, “application measurement configuration”, “QoE measurement configuration”, “QoE configuration” and “QoE measurement and reporting configuration” are used interchangeably.

The terms “modem”, “radio layer”, “RRC layer” and “radio network layer” are used interchangeably when referring to a UE.

The terms “access stratum” and “radio layer” are used interchangeably when referring to a UE.

Every feature in the embodiments described below that is applicable to session stop indications also applies to session end indications, and, likewise, every feature that is applicable to session end indications also applies to session stop indications.

The terms “service subtype” and “subservice type” are used interchangeably.

The term “session” or “application session” may refer to either a QoE measurement session or an application session for which QoE measurement is applied.

The terms “Handover Command” and “HandoverCommand” are used interchangeably.

The embodiments described herein may apply to UMTS, LTE and NR.

All references to the application layer are with respect to the application layer of the UE (since RAN nodes do not have an application layer).

The embodiments described herein may apply to both signaling- and management-based QoE measurements (but may also optionally be restricted to apply to only one of them).

Even though primarily described when applied in conjunction with conditional handover, the embodiments described herein may be applicable also to other conditional mobility related procedures, such as conditional PSCell change or conditional PSCell addition or conditional SCell addition.

In the present description, the UE's “source cell configuration” refers to the configuration the UE applies in the source cell. Similarly, the UE's “target cell configuration” or “candidate target cell configuration” refers to the configuration the UE applies in the target cell or candidate target cell.

The embodiments are described primarily in 5G/NR terms, implying application of the solution in 5G/NR, but the embodiments are also applicable in LTE (in which case for instance a gNB would be replaced by an eNB, and an RRCReconfiguration message would be replaced by an RRCConnectionReconfiguration message) or UMTS.

When CHO is configured for a UE, a cell which the UE potentially can connect to (i.e., if the CHO execution condition is fulfilled for the cell) is denoted as “candidate target cell.” Similarly, a RAN node controlling a candidate target cell is denoted as “candidate target node.” During the actual execution of the CHO and when the UE has connected to the new cell, the concerned cell may be referred to as either a “candidate target cell” or a “target cell.” Similarly, a RAN node controlling such a cell, may in this situation be referred to as either a “candidate target node” or a “target node.”

The source node does not update the candidate target nodes when the session status changes for a QoE configuration for a UE for which CHO has been configured (but not executed). To compensate for the knowledge/information “void” that this creates for the candidate target nodes, when the UE connects to the target node, the UE provides one or more status indications to the target node that indicates the status of the UE's sessions. In some embodiments, the session status indication may be an indication of whether the application session is ongoing or not ongoing at the time of the CHO (i.e., an ongoing/not ongoing status). In some embodiments, the session status indication may include one or more session start/stop/end indications for an application session of the UE that were generated while the UE was configured for CHO. As noted above, in this regard, a “session” refers to a QoE measurement session or an application session for which QoE measurement is applied.

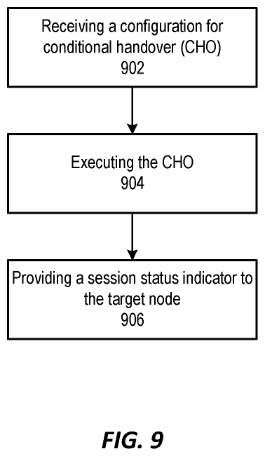

Operations of a UE according to some embodiments are illustrated in FIG. 9. As shown therein, a method performed by a user equipment, UE, in a wireless communication network includes receiving (block 902) a configuration for a conditional handover, CHO, from a source node to a candidate target node, and executing (block 904) the CHO to the candidate target node. The UE indicates (block 906) to the candidate target node a session status indication for an application session in connection with executing the CHO. The session status indication may include an ongoing/not ongoing status for the application session and/or one or more start/stop/end indications for the application session that were generated while the UE was configured for CHO.

The session status indication may be indicated per quality of experience, QoE, configuration in the UE. That is, a session status indication may be provided for each QoE configuration in the UE.

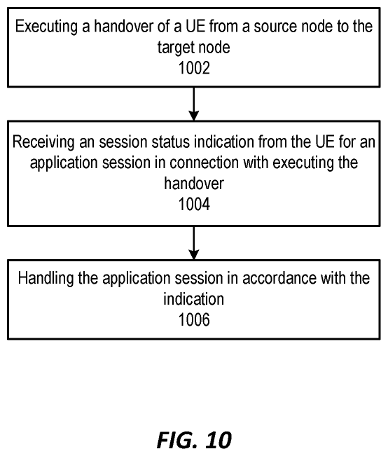

Operations of a candidate target node according to some embodiments are illustrated in FIG. 10. As shown therein, a method performed by a target node in a wireless communication network includes executing (1002) a handover of a UE from a source node to the target node. In connection with the handover, the candidate target node receives (1004) a session status indication from the UE indicating a status for an application session in connection with executing the handover, and handles (1006) the application session in accordance with the indication. A session status indication may be provided for each QoE configuration in the UE.

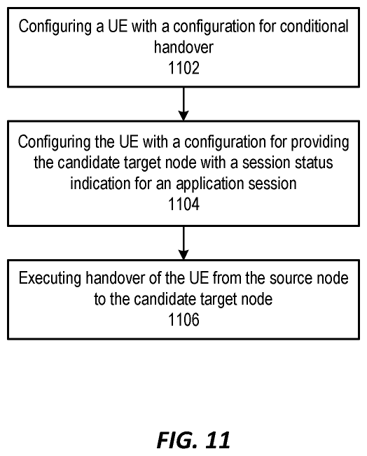

Operations of a source node according to some embodiments are illustrated in FIG. 11. As shown therein, a method performed by a source node in a wireless communication network includes configuring (1102) a UE with a configuration for conditional handover, CHO, to a candidate target node, configuring (1104) the UE with a configuration for providing the candidate target node with a session status indication for an application session, and executing (1106) a handover of the UE from the source node to the candidate target node. A session status indication may be provided for each QoE configuration in the UE.

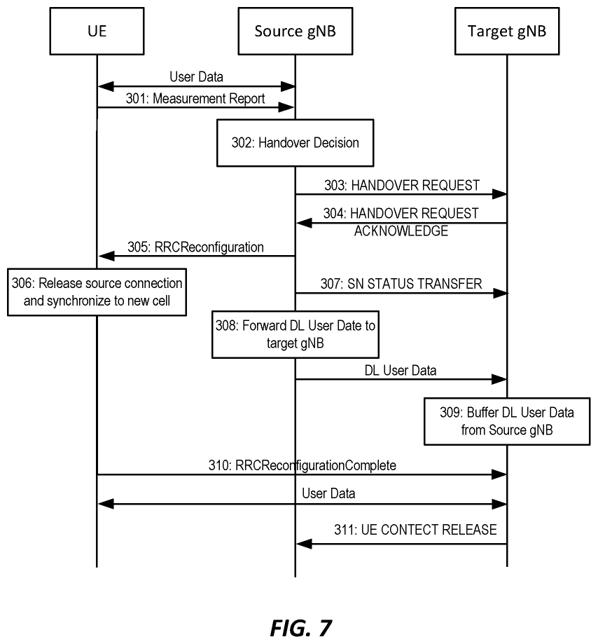

When providing the target node with the session status indication, one option is that the UE includes the session status indication in the RRCReconfigurationComplete message (in NR) that informs the target node that the conditional handover has been successfully completed, i.e. the first RRC message—indeed the first message above the MAC layer—in the target cell, which is commonly referred to as the Handover Complete message (i.e. message 310 in FIG. 7. Other options include that the UE sends the session status indication in separate unsolicited RRC message, e.g. a MeasurementReportAppLayer message, a UEAssistanceInformation message, or some other RRC message, e.g. sent on SRB4, or that the UE sends the session status indication in a separate RRC message (e.g. a new message, a MeasurementReportAppLayer message or a UEInformationResponse message or a UEAssistanceInformation message) in response to a request from the target node (where the request e.g. may be included in a UEInformationRequest message), or that the UE sends the session status indication in a MAC CE (with or without a preceding request from the target node) or that the UE sends the session status indication in an RRC message without a request from the network e.g., in UEAssistanceInformation message.

A session status indication could be a flag possibly associated with a measurement ID corresponding to a QoE measurement. The session status indication should therefore be associated with a reference to the concerned QoE configuration, e.g. the measConfigAppLayerId (which is often referred to as the RRC ID) or the QoE reference. This status indication could e.g. an optional parameter defined in ASN.1 as being of type ENUMERATED with the single defined value “true” (e.g. sessionOngoing ENUMERATED {true}) whose inclusion in the message indicates “session ongoing” and whose absence in the message indicates “session not ongoing”. Another option could be that the session ongoing/not ongoing status indication could be a Boolean parameter, e.g. a parameter defined in ASN.1 as being of type BOOLEAN, for which the value true indicates that a session is ongoing and the value false indicates that no session is ongoing. Yet another option could be that a (retroactive) session start indication indicates that a session is ongoing for a certain QoE configuration, while a (retroactive) session stop/end indication indicates that no session is ongoing.

Yet another option could be that a (retroactive) session start indication indicates that a session is ongoing for a certain QoE configuration, while absence of such a (retroactive) session start indication indicates that no session is ongoing for the concerned QoE configuration. As yet another option, the UE could send all stored session start/stop/end indications that have been generated while the UE was configured with CHO. Irrespective of how the session status is signaled, it should be indicated per QoE configuration in the UE.

The source node may, in some embodiments, send in the conditional handover preparation information to each candidate target node, the UE's session status (per QoE configuration in the UE) at the time of sending the UE's configuration in the source cell to the candidate target node. As another embodiment, the source node may not include any information at all about the UE's session status in the conditional handover preparation information sent to the candidate target nodes. The UE's session status may be part of the configuration (e.g. UE context) that is always forwarded from the source node to the target node at handover. In such a case, one additional indication may be needed to inform the target node to not take any notice of/consider the session status. In one solution, the request for a conditional reconfiguration (e.g. CHO) serves as an indication to the target node to ignore the session status when preparing the conditional reconfiguration.

Regarding sending session start/stop/end indications in the source cell to the source node, as one alternative, the may UE keep sending session start/stop/end indications to the source node while configured with CHO, but the source node does not forward any of this information (or any other update or indication of changed session ongoing/not ongoing status) to the candidate target nodes.

As another alternative, the UE does not send any session start/stop/end indications to the source node while configured with CHO.

Whether the UE should refrain from or keep sending session start/stop/end indications to the source node may be configured by the source node, either via dedicated signaling or via broadcast signaling (e.g. the broadcast system information), or may be specified in standard specification(s).

In both the above alternatives (i.e., sending or not sending session start/stop/end indications in the source cell while the UE is configured with CHO), as one option, the UE stores the generated (but, in case of the second alternative, not sent) session start/stop/end indications for later transmission to a possible target node. As another option, the UE stores the generated (but, in case of the second main solution variant, not sent) session start/stop/end indications, but discards them as new ones are generated, such that only the latest indication (per QoE configuration or per application/QoE measurement session) is kept for later transmission to a possible target node.

As yet another option, the UE may delete/discard any session start/stop/end indication that is generated while the UE is configured with CHO, or the UE ensures that no session start/stop/end indications are generated, regardless of session start/stop/end events occurring in the UE. Such a self-configuration may be realized by the UE Access Stratum sending an AT command to the UE application layer, instructing it not to generate any session start/stop/end indications (indicated per QoE configuration, e.g. using the measConfigAppLayerId, or to be applied to all QoE configurations in the UE).

As a further option, if the UE has stored any session start/stop/end indications for later transmission to a possible target node, the UE does not send these indications 1) if it connects to a target node which is the same node as the source node, or 2) if the target node it connects to has indicated in the target configuration it has provided to the UE (to be applied in the concerned target cell, i.e. the HandoverCommand) that the UE should not send any stored session start/stop/end indications when connecting to this target node (in the concerned target cell), or 3) if the UE connects to a target node that the UE can conclude does not support the feature i.e. is not able to use the session start/stop/end indications (e.g. a target node of another radio access technology (RAT)—for instance, if a QoE feature is introduced in NR, the LTE nodes supporting QoE may not support it).

The UE's behavior, as well as any of the previously and subsequently described methods and features, in all of the above-described embodiments/alternatives/options and solution variants, may be fully or partially configured (or specified in standard specification(s)) in the UE in various ways. For example, the UE's behavior may be indicated in the broadcast system information of the source cell.

In some embodiments, the UE's behavior may be indicated in the broadcast system information of the target cell.

In some embodiments, the UE's behavior may be indicated in dedicated signaling, e.g. RRC signaling, MAC signaling or in DCI transmitted on the PDCCH.

In some embodiments, the UE's behavior may be indicated together with each QoE configuration (e.g. provided in the same message as the QoE configuration).

In some embodiments, the UE's behavior may be indicated in an update of a QoE configuration, the update/modification being sent by the source node or target node.

In some embodiments, the UE's behavior may be indicated by the source node in the RRCReconfiguration message configuring the UE for CHO. The indication could be per QoE configuration and/or per candidate target cell, per candidate target node or for CHO in general.

In some embodiments, the UE's behavior may be indicated by the candidate target node in the (conditional) handover command, i.e. the RRCReconfiguration sent to the UE via the source node as part of the CHO configuration, which the UE should apply when it connects to the candidate target node in the candidate target cell. This method may be used e.g. to allow the candidate target node to indicate to the UE whether it wants the UE to send information about its session status (or which type of such information the candidate target node wants to receive) when/if the UE connects to the candidate target node in a candidate target cell.

In some embodiments, the UE's behavior may be indicated in an acknowledgement of a session start indication (but not in an acknowledgement of a session stop indication or session end indication) received while the UE was configured for CHO. The indication could be per QoE configuration and/or per candidate target cell or per candidate target node (or for CHO in general).

In some embodiments, the UE's behavior may be indicated in an acknowledgement of a session stop indication or session end indication (but not in an acknowledgement of a session start indication) received while the UE was configured for CHO. The indication could be per QoE configuration and/or per candidate target cell or per candidate target node (or for CHO in general).

In some embodiments, the UE's behavior may be indicated in an acknowledgement of a session start, session stop, or session end indication received while the UE was configured for CHO. The indication could be per QoE configuration and/or per candidate target cell or per candidate target node (or for CHO in general).

In some embodiments, the UE's behavior may be indicated in standard specifications (and thus hardcoded in the UE).

In some embodiments, the UE's behavior may be configured in the universal subscriber identity module (USIM) at the time of subscription (or later using over the air configuration of the USIM).

In some embodiments, the UE's behavior may be configured in the UE via over the air configuration means.

Any combination of the above configuration/specification alternatives may be used, e.g. with some parts of the features and/or UE behavior being configured (or specified in standard specification(s)) in one way and other parts of the features and/or UE behavior being configured (or specified in standard specification(s)) in other ways. Combinations of multiple configuration and specification means are conceivable. When multiple configuration means and/or specification means are combined, they can complement each other (e.g. applying to one part of the features and/or UE behavior each) or partly overlap in the sense that the same feature and/or UE behavior may be subject to multiple configuration and/or specification means. In the latter case (i.e. the partial configuration/specification overlap case), one configuration means may have precedence over the others (i.e. if some of the configuration data is provided through other means too, this is overridden by the corresponding configuration data in the configuration means with precedence, or, as another alternative, the latest received configuration data overrides any previously received corresponding configuration data, irrespective of configuration/specification means. Combinations of configuration and/or specification means may also be combined such that the data provided through one means refers to data provided through another means. For instance, different options, e.g. in the form of parameter tables, may be specified in standard specification(s), while configuration data provided via signaling indicates which of the specified options that the UE should apply (e.g. indicating a set of parameter values using a table row index pointing at a table row in a specified table of parameter values).

In all the above alternatives where the UE's behavior is configured (i.e. not fully mandated by standard), the UE's behavior in the source cell, e.g. sending/not sending start/stop/end indications, and storing or not storing start/stop/end indications generated during CHO (whether transmitted or not) for later transmission in the target cell, or storing only the last one (i.e. the last one always replaces the previous last one (per QoE configuration in the UE)), this configuration is determined and provided by the source node and may be included in the RRCReconfiguration message providing the CHO configuration to the UE (but not inside any HandoverCommand).

As one further embodiment related to the UE's behavior, the source node includes the UE's session status indication in the HANDOVER REQUEST XnAP message (or in the HANDOVER REQUIRED NGAP message) to inform the candidate target node, and the UE is configured, or mandated by standard specification(s), to remember the session status it had at the time when it received the CHO configuration, and to report its session status when it connects to a candidate target node in a candidate target cell only if the session status at that point in time is different from what it was at the time when the UE received the CHO configuration.

When the UE reports this status to the candidate target node, it can do this by sending an indication of the current status. As alternative, if the status has changed from session ongoing to session not ongoing for a QoE configuration, the UE may indicate the current status by sending a session stop or session end indication to the candidate target node, and if the status has changed from session not ongoing to session ongoing for a QoE configuration, the UE may indicate the current status by sending a session start indication. As yet another alternative, the UE may indicate that the session status for a QoE configuration has changed by sending a simple indication, e.g. in the form of a flag or a single bit, indicating that the session status for the concerned QoE configuration has changed since the CHO was configured. If this UE behavior is configured, it may be indicated e.g. in the RRCReconfiguration message providing the CHO configuration (either in the HandoverCommand provided by the candidate target node or in the part of the message with information provided by the source node) or in the broadcast system information.

As a more detailed example of this embodiment, the UE may only store/save the latest state of the applications sessions at the time of receiving the CHO configuration in a first variable. The UE logs any change of the status of the sessions (in terms of being started/stopped/ended) in a second variable different from the first variable. The UE, upon successful execution of the CHO handover, informs the target node about the difference of the status of the sessions, i.e., only informing the target node about the sessions in which their status has changed from the time of receiving the CHO configuration to the time of CHO execution.

In yet another embodiment, if the UE receives a second CHO configuration after receiving a first CHO configuration (where the first CHO configuration has not been executed), it sends an updated version of session status for each QoE configuration in the UE to the serving node (i.e. the source node) and stores the second version of the session status variable in the local memory. Upon successfully executing the second CHO configurations, the UE updates the target node with the difference between the session status at the time of execution of the second CHO and at the time of receiving the second CHO configuration.

Note that if there is no difference between in the sessions status at the time receiving the CHO configuration and the time of CHO execution, the UE does not indicate anything to the target node.

In another variant, where the UE configured with CHO sends possible session start/stop/end indications to the source node, the source node indicates the new status to the target node by means of a message for updating the CHO configuration. This may involve replacing the old CHO configuration in each candidate target node with a new CHO configuration (e.g. releasing the old CHO configuration and providing a new CHO configuration), or, alternatively, the source node may use a message that provides updated information (the full information or only the updated parts), which the candidate target node can apply to its existing CHO configuration.

In another variant, in one embodiment the target node makes a guess of the ongoing session status in the UE. If e.g. the target cell is outside the area scope of the QoE configuration, but the source node is within the area scope, the target node includes an out-of-area release indication to the UE when the UE has connected to the target node. If the UE gets such an out-of-area release indication it may reply with an indication to the target node that there is an ongoing session and that it did not release the QoE configuration yet. If the target node is within the area scope, the QoE configuration should be kept in the UE in any case, independently of the session status.

As an option, the candidate target node could be able to indicate in the HANDOVER REQUEST ACKNOWLEDGE XnAP (or NGAP) message whether it wants the UE to report its session status upon/after CHO execution. This may be useful if the candidate target node does not use any method that requires knowledge of the session status in the UE. As a further option, the candidate target node could be able to indicate in the HANDOVER REQUEST ACKNOWLEDGE XnAP (or NGAP) message which type of session status related information it wants to receive, e.g. the current status in the form of an ENUMERATED parameter or a BOOLEAN parameter or the accumulated (stored in the UE) session start/stop/end indications that have been generated in the UE since the UE was configured for CHO.

In one scenario, the CHO can be initiated by the source node to prepare a candidate target node wherein the source node and the candidate target node belong to different Radio Access Technologies (RATs). For example, the source node is an NG-RAN node which is a gNB providing NR user plane and control plane protocol termination and connected to a 5GC core network, while the candidate target node is an NG-RAN node which is a ng-eNB providing E-UTRA user plane and control plane protocol termination and connected to a 5GC core network.

### Handling Lack of Support in the Candidate Target Node

As one option, the source node can indicate to a candidate target node during the conditional handover preparation phase, e.g. in the HANDOVER REQUEST XnAP message or the HANDOVER REQUIRED NGAP message, that the UE will indicate its session status when it connects to a candidate target cell controlled by the candidate target node. In the case the candidate target node does not support this feature, it can then perform one of the following (non-limiting) actions.

In one embodiment, the candidate target node may return an indication of failure of the preparation of the conditional handover. This may have the form of e.g. a HANDOVER PREPARATION FAILURE XnAP message, e.g. including an indication, e.g. a cause value, indicating, e.g., a lack of support for the feature where the UE signals information related to its session status for one or more QoE configurations when it connects to the candidate target node in a candidate target cell, a lack of support for QoE, partial support for QoE, or failure to understand part of the CHO configuration information.

In one embodiment, the candidate target node may return an indication that the candidate target node does not support the feature where the UE signals information related to its session status for one or more QoE configurations when it connects to the candidate target node in a candidate target cell. This may e.g. be an indication in a HANDOVER REQUEST ACKNOWLEDGE message.

In one embodiment, the candidate target node may configure the UE with full configuration to be applied when/if the UE connects to the candidate target node upon during a successful execution of the CHO, where the reporting of the UE's session status in the candidate target cell is excluded (or canceled).

In one embodiment, the candidate target node may ignore the indication, i.e., does not provide in the response message any IE pertaining to the IEs related to status indication in the request message, based on which the source node can conclude the lack of support at the target node.

If the candidate target node returns a failure indication (e.g. a HANDOVER PREPARATION FAILURE XnAP message) with an indication, e.g. a cause value, indicating lack of support for the feature where the UE signals information related to its session status for one or more QoE configurations when it connects to the candidate target node in a candidate target cell, the source node may choose to do one of the following actions.

In one embodiment, the source node may provide new conditional handover preparation information to the candidate target node, this time not indicating that the UE will send information related to its session status when it connects to the candidate target node. The source node will then also configure the UE not to send information related to its session status when it connects to the candidate target node (ore refrain from configuring the UE to do so).

In one embodiment, the source node may exclude the candidate target node an its cells from the potential candidate target cells/nodes for which CHO will be configured for the UE.

If the candidate target node accepts the CHO configuration (i.e. does not return a failure indication), but indicates in the response (e.g. in the HANDOVER REQUEST ACKNOWLEDGE XnAP message) that it does not support the feature where the UE signals information related to its session status for one or more QoE configurations when it connects to the candidate target node in a candidate target cell, the source node may choose to do one of the following.

In one embodiment, the source node may configure the UE not to send information related to its session status when it connects to the candidate target node (ore refrain from configuring the UE to do so).

In one embodiment, the source node may send a new, updated CHO configuration to the candidate target node, e.g. in a new HANDOVER REQUEST XnAP message, this time not indicating that the UE will send information related to its session status when it connects to the candidate target node. The source node will then also configure the UE not to send information related to its session status when it connects to the candidate target node (ore refrain from configuring the UE to do so).

In one embodiment, the source node may abort the configuration of CHO for that candidate target node and exclude the candidate target node an its cells from the potential candidate target cells/nodes for which CHO will be configured for the UE.

In both the above alternative cases of indications of lack of support from the candidate target node (i.e. failure indication or indication of lack of support for the feature where the UE signals information related to its session status for one or more QoE configurations when it connects to the candidate target node in a candidate target cell, the source node may use the information received from the candidate target node as part of the basis for selecting potential candidate target cells/nodes for CHO configuration. This may be applied for the CHO configurations of the UE for which the current CHO configuration was intended (i.e. the CHO configuration that triggered the candidate target node to return the failure indication or indication of lack of support), and/or it may be applied for future CHO configurations in general.

### Handling Cases Where the HandoverCommand Contains Full Configuration

A HandoverCommand typically contains configuration information that indicates the changes the UE should apply to its source cell configuration to arrive at the target cell configuration. This is referred to as “delta-configuration”. But the candidate target node (or the target node during regular handover) also has the option to include a full configuration in the HandoverCommand to provide the UE with a full configuration to be applied in the target cell, i.e. a configuration which fully replaces the UE's source cell configuration. The target node does this by including the fullConfig parameter (which is an ASN.1 ENUMERATED parameter with the only possible value being “true”) in the HandoverCommand.

Hence, when the UE executes a HandoverCommand including the fullConfig parameter, it discards its source cell configuration and instead applies the configuration included in the HandoverCommand. This means that any configuration/information related to the UE's behavior when it has connected to the target cell would be deleted before it can be applied, if it is contained in the source cell configuration. This is a complicating aspect for the embodiments/options where the source node provides such a source cell configuration to the UE, e.g. where the source node configures the UE to send the UE's session status (per QoE configuration in the UE) to the candidate target node when/if the UE connects to the candidate target node. There are several ways to address this issue.

A straightforward workaround to the issue is to specify that the configuration governing the UE's behavior with regards to the sending of the session status to the target node is exempt from the source configuration that the UE discards when it applies the target cell configuration (and the target cell configuration includes the fullConfig parameter), but when the UE has performed the actions (if any) in accordance with this configuration, it discards the configuration. I.e. this part of the source configuration is not discarded immediately, but only after the UE has “executed” it in the target cell.

Another alternative is that the candidate target node determines the configuration of the UE's behavior when it connects to the candidate target node and conveys it to the UE in the HandoverCommand.

Yet another alternative is that the source node determines the configuration, but sends it to the candidate target node in the HANDOVER REQUEST message, and the candidate target node puts it in the HandoverCommand (sort of on behalf of the source node). This way, the configuration in practice becomes a part of the candidate target cell configuration.

Yet another alternative is that the source node provides the configuration to the UE in the source cell configuration (e.g. in the RRCReconfiguration message carrying the CHO configuration to the UE, but not inside any HandoverCommand in this RRCReconfiguration message), but the specification is rewritten such that the UE performs its actions according to the configuration (e.g. sends the session status to the target node), if there is any such configuration before it discards its source configuration (when the target cell configuration includes the fullConfig parameter). Note that there is also the alternative that the UE's behavior (e.g. to send its session status (per QoE configuration in the UE) when it connects to a target node) is not configured, but mandated by standard, and then it is not even part of the UE's source cell configuration (i.e. the problem never arises).

If a UE has a configuration in its source cell configuration stipulating that the UE should sent its session status (per QoE configuration in the UE) to the candidate target node when/if it connects to it, and the UE is not to discard this configuration when executing a HandoverCommand (as described as an option above), this exemption from discarding may be applied also to QoE configurations in the UE, or the UE Access Stratum's knowledge of QoE configuration(s) residing at the UE's application layer, e.g. represented by measConfigAppLayerId parameters stored in the UE Access Stratum. Optionally, the exemption from discarding may also apply to any yet unsent QoE report(s) stored in the UE (either in the UE Access Stratum or at the UE application layer) (even though such QoE reports strictly speaking possibly may not be seen as part of the UE's source cell configuration as such (but rather a result of applying the source cell configuration)).

Note also that a UE's QoE configuration(s) (and the UE Access Stratum's knowledge thereof, and possibly stored unsent QoE reports) may be exempt from the source cell configuration the UE discards when it applies a HandoverCommand including the fullConfig parameter, even if such exempting does not apply to a source cell configuration stipulating the UE's behavior when it connects to the candidate target node (e.g. that the UE should send its session status (per QoE configuration in the UE) to the candidate target node when/if it connects to the candidate target node).

As yet another option, if the target node provides a HandoverCommand including the fullConfig parameter, this may be a result of lack of support for the herein described mechanism(s) to handle session status information in conjunction with CHO (e.g. that the UE should send its session status (per QoE configuration in the UE) to the candidate target node when/if it connects to the candidate target node), or may be assumed to be a result of such lack of support (possibly as a result of lack of support for the entire QoE framework, or certain parts of the QoE framework, such as handling session start/stop/end indications). Hence, as yet another option, the UE may apply the legacy (currently specified, e.g. in 3GPP Release 16) treatment of the source cell configuration when it executes a HandoverCommand including the fullConfig parameter, i.e. to discard the source cell configuration, and to let this discarding also apply to any information in the source cell configuration related to the UE's behavior when it has connected to the target node (e.g. that the UE should send its session status (per QoE configuration in the UE) to the candidate target node when/if it connects to the candidate target node).

### Extending the Solution to the Pause/Resume of QoE Reporting Mechanism

A feature that is expected to be standardized for QoE for NR is the possibility for the network to send an instruction to the UE to pause (or resume) sending of QoE reports. This can be indicated per QoE configuration in the UE and possibly there will also be a possibility to indicate that QoE reporting is paused/resumed for all QoE configurations in the UE. This pause QoE reporting feature is primarily intended to be used when the network experiences an overload condition (in the radio interface or in the processing capacity or some other resource) and makes the UE stop sending QoE reports, as instructed, until a corresponding instruction to resume the QoE reporting is sent from the network to the UE.

The above described embodiments may be generalized such that their principal features apply also to indications of pause/resume of QoE reporting and/or the UE's paused/not paused QoE reporting status (per QoE configuration in the UE). To this end, when CHO is configured for a UE, the serving/source node may avoid updating the UE context previously sent to candidate target node(s) when/if the UE's status with regards to sending of QoE reports (e.g. whether the sending of QoE reports (e.g. per QoE configuration in the UE) is paused or not) changes. To compensate for the lack of up-to-date information this may cause in a candidate target node, the UE informs the target node of whether its QoE reporting (possibly per QoE configuration in the UE) is paused or not.

The UE may do this in the RRCReconfigurationComplete message constituting the Handover Complete messages, but the other alternatives described for how the UE can inform the target node about its session status (per QoE configuration in the UE) may also be applied for informing the target node about the status of QoE reporting (i.e. paused or not). The various configuration alternatives described for the UE's behavior and features and parameters regarding how session status indications are handled may be used also for configuration of the UE's behavior and features and parameters when the solution is applied to indication of pause/resumed/not paused status for sending of QoE reports.

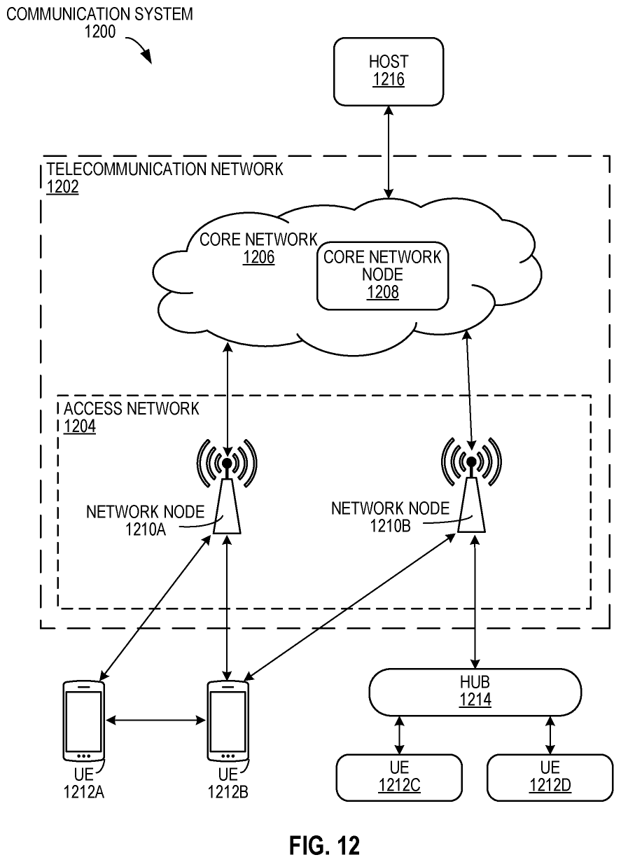

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub-that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

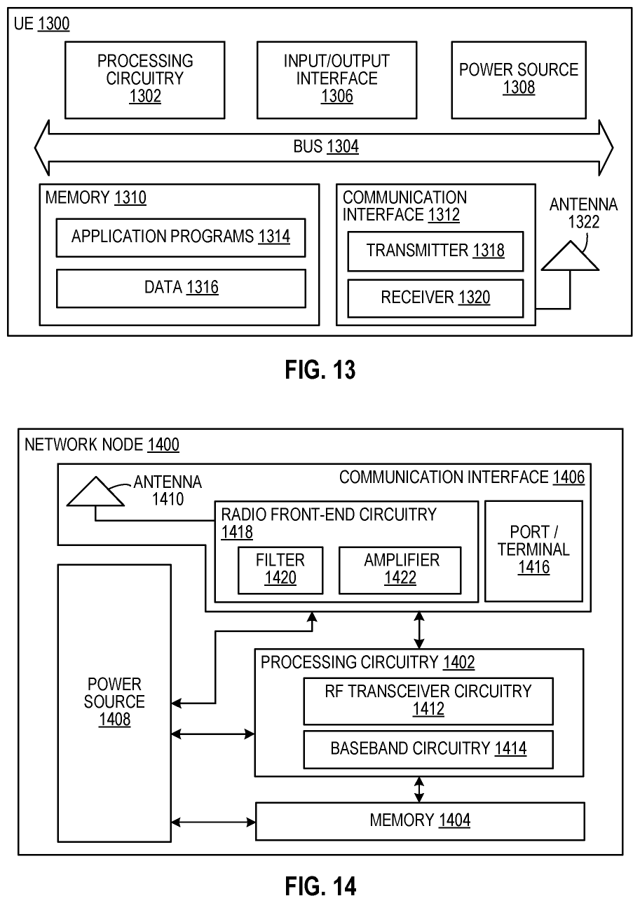

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection.

The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

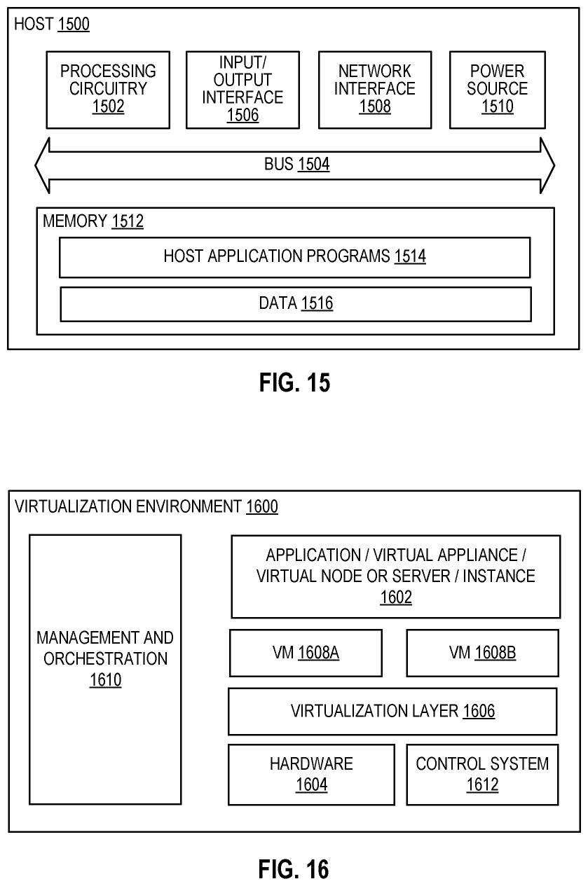

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

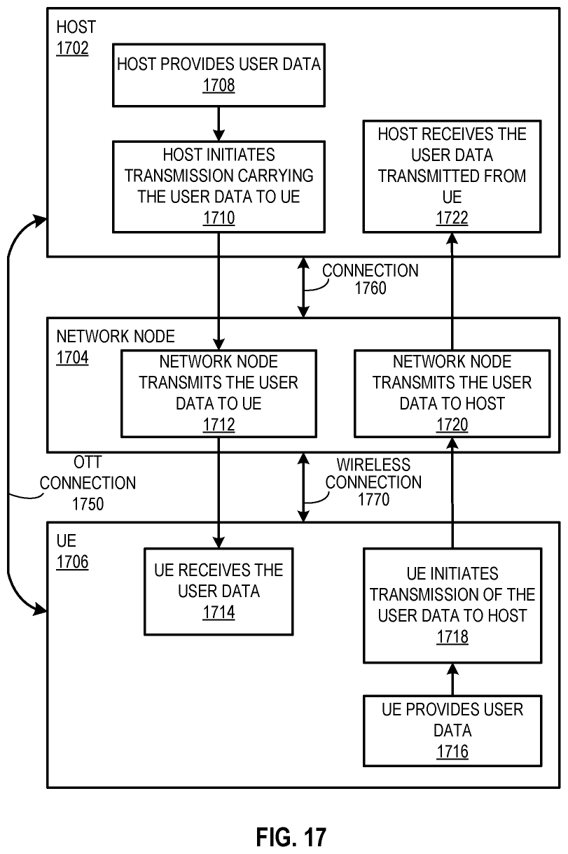

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve the efficiency of network operation by potentially avoiding extensive and unnecessary inter-gNB and gNB-UE signaling of configuration updates and thereby provide benefits such as reduced delays and better responsiveness.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, in a wireless communication network, comprising:
receiving a configuration for a conditional handover, CHO, from a source node to a candidate target node;
executing the CHO to the candidate target node; and
in connection with executing the CHO, providing to the candidate target node a session status indication for an application session of the UE.

2. The method of claim 1, wherein the session status indication comprises an indication of an ongoing/not ongoing status of the application session.

3. The method of claim 1, wherein the session status indication comprises one or more session start/stop/end indications for the application session that were generated while the UE was configured for the CHO to the candidate target node.

4. The method of claim 1, wherein the session status indication is associated with a quality of experience, QoE, configuration in the UE.

5. The method of claim 4, wherein the application session comprises a QoE measurement session or an application session for which QoE measurement is applied.

6. The method of claim 1, wherein the session status indication is provided to the candidate target node in a radio resource control, RRC, message.

7. The method of claim 6, wherein the RRC message comprises a RRCReconfigurationComplete message, a Handover Complete message, a MeasurementReportAppLayer message, a SRB4 message, or a UEAssistanceInformation message.

8. The method of claim 1, further comprising:
storing one more session start/stop/end indications that were generated while the UE was configured for CHO to the source node.

9. The method of claim 8, wherein the UE stores only a latest session start/stop/end indication that was generated while the UE was configured for CHO to the source node.

10. (canceled)

11. The method of claim 1, further comprising:
receiving a configuration for handling session status indications as part of a CHO; and
implementing the configuration for handling session status indications.

12. The method of claim 11, wherein the configuration for handling session status indications is:
indicated in broadcast system information of a target cell;
indicated in dedicated signaling to the UE;
indicated together with an associated QoE configuration;
indicated in an update of a QoE configuration provided by the source node or the candidate target node;
indicated by the source node in an RRCReconfiguration message configuring the UE for CHO;
indicated by the candidate target node in a CHO command;
indicated in an acknowledgement of a session start indication received while the UE was configured for CHO;
indicated in an acknowledgement of a session stop indication or session end indication received while the UE was configured for CHO;
indicated in a standard specification; and/or
configured in a Universal Subscriber Identity Module of the UE at time of subscription.

13. The method of claim 1, further comprising:
receiving a second configuration for CHO while configured for CHO;
sending an updated version of session status indication for each of a plurality of QoE configurations in the UE to the source node; and
upon successfully executing the second configuration for CHO, indicating to the candidate target node a difference between a session status at the time of execution of the second configuration for CHO and at the time of receiving the second configuration for CHO.

14.-17. (canceled)

18. A method performed by a target node in a wireless communication network, comprising:
receiving a conditional handover, CHO, of a user equipment, UE, from a source node to the target node;
in connection with the CHO, receiving a session status indication indicating a status for an application session of the UE; and
handling the application session in accordance with the session status indication.

19. The method of claim 18, further comprising:
receiving a handover request indicating that it is a candidate node of a CHO procedure involving the UE, wherein the handover request includes the session status indication.

20. The method of claim 18, wherein the session status indication is indicated per quality of experience, QoE, configuration in the UE.

21. The method of claim 18, wherein the session status indication is received in a radio resource control, RRC, message.

22. The method of claim 21, wherein the RRC message comprises a RRCReconfigurationComplete message, a Handover Complete message, a MeasurementReportAppLayer message, a SRB4 message, or a UEAssistanceInformation message.

23.-27. (canceled)

28. A method performed by a source node in a wireless communication network, comprising:
configuring a user equipment, UE, with a configuration for conditional handover, CHO, to a candidate target node;
configuring the UE with a configuration for providing to the candidate target node a session status indication for an application session of the UE; and
executing a handover of the UE from the source node to the candidate target node.

29. The method of claim 28, wherein the configuration for providing the session status indication for the application session is provided per quality of experience, QoE, configuration in the UE.

30. The method of claim 28, wherein the source node provides the configuration for providing the session status indication:
in broadcast system information of a target cell;
in dedicated signaling to the UE;
together with an associated QoE configuration;
in an update of a QoE configuration provided by the source node or the candidate target node;
in an RRCReconfiguration message configuring the UE for CHO;
in an acknowledgement of a session start indication received while the UE was configured for CHO;
in an acknowledgement of a session stop indication or session end indication received while the UE was configured for CHO; and/or
in a standard specification.

31.-38. (canceled)
